(19) United States
(12) Patent Application Publication
(10) Pub. No.: US 2005/0127858 A1
(43) Pub. Date: Jun. 16, 2005

(54) PWM motor control in the current mode with positive disconnection

(75) Inventor: Radu Liviu Florea, Nurnberg (DE)

Correspondence Address: LERNER AND GREENBERG, PA, P O BOX 2480, HOLLYWOOD, FL, 33022-2480, US

(73) Assignee: Diehl AKO Stiftung & Co. KG

(21) Appl. No.: 11/000,634

(22) Filed: Dec. 1, 2004

(30) Foreign Application Priority Data
Dec. 12, 2003 (DE) 103 58 129.4

(51) Int. Cl. H02P 7/06

(52) U.S. Cl. 318/254

(57) ABSTRACT

In order to suppress noise emission caused by pulse-width modulation in the current mode in the case of an electric motor, a method and a control unit for carrying out the method are specified. Here, provision is made for a PWM signal to be subjected to positive disconnection for a predetermined minimum switching time within each clock of a clock signal that clocks the PWM signal.

### BACKGROUND OF THE INVENTION

### Field of the Invention

The invention relates to a method for pulse-width-modulated control of a drive current for an electric motor. The invention also relates to an associated control unit producing the drive current.

In a large number of fields of engineering, brushless electric motors have been used for drive purposes. The use of such a motor as a drive for a hard-disk drive is customary to the same extent as the use of such a motor as a vehicle drive. Brushless electric motors are also used in domestic appliances (refrigerators, washing machines, etc.) and as drives for industrial machines.

In the case of a brushless electric motor in the form of a synchronous motor, correspondingly switching two or more phases of the motor produces an electromagnetic rotating field which brings about a mechanical torque between the stator and the rotor of the electric motor and thus drives the rotor such that it rotates following the rotational frequency of the rotating field. The term phase is used in this case in the narrower sense to refer to a component of the rotating field. An electric motor contains at least two, often three, such phases which are disposed with respect to the rotor axis such that they are offset with respect to one another by an angle and which superimpose one another additively so as to form the rotating field. Each of these field components is produced by an associated electric coil configuration that will also always be included in the term “phase” below. In the case of a brushless electric motor, the phases, and thus the electromagnetic rotating field, are often associated with the stator of the electric motor, whereas the rotor contains a permanent magnet.

The characterizing feature of a brushless electric motor is the fact that the phases are electronically commutated, i.e. switched. The control unit producing the drive current for the electric motor conventionally contains, for each phase, one pair of electronic circuit breakers that are driven by a phase controller.

It is usual to control the rotational speed and the power of such an electric motor by phase gating and/or phase chopping of the phase-rectified drive current. Such methods are described, for example, in Published, Non-Prosecuted German Patent Application DE 101 32 486 A1, corresponding to U.S. Patent Application Publication No. 2004/0139767 A1 and Published, Non-Prosecuted German Patent Application DE 43 01 203 A1.

As an alternative, the rotational speed or power of the electric motor may be controlled by so-called pulse-width modulation (PWM). In this case, the drive current that is supplied to a phase during a commutation period is divided into a series of short pulses. A width, i.e. the duration, of these pulses is modulated such that the desired rotational speed or power is reached.

In the case of conventional pulse-width modulation operated in a so-called current mode, in each case one control pulse of a PWM signal is started at time intervals predetermined by a clock generator. The control pulse in turn switches the drive current in the phase that is to be controlled of the electric motor, as a result of which the motor current rises successively. The control pulse is then maintained until the motor current exceeds a predetermined reference value. When the reference value is exceeded, the control pulse is interrupted, and, correspondingly, the motor phase is again disconnected such that the motor current decreases successively. On the next clock pulse of the clock generator, the next control pulse is then started and the described cycle is repeated.

The frequency of the clock signal is generally selected to be outside the audible frequency spectrum, in particular of the order of magnitude of 20 kHz. This is intended to prevent the formation of a sound wave, which is brought about during the pulse-width modulation of the drive current in the electric motor, from resulting in audible noise production and thus in a possible noise load.

Under specific working conditions, however, it is possible for the reference value of the motor current not to be reached within one clock period. The control pulse of the PWM signal thus remains over two or more clock cycles in the case of conventional PWM control. The PWM signal, and thus also the drive current, may thus obtain frequency components in the audible frequency range which, during operation of the motor, result in noise production which is sometimes disruptive.

### SUMMARY OF THE INVENTION

It is accordingly an object of the invention to provide in a PWM motor control in the current mode with positive disconnection which overcome the above-mentioned disadvantages of the prior art methods and devices of this general type, in which audible noise production is suppressed as a result of the pulse-width modulation.

With the foregoing and other objects in view there is provided, in accordance with the invention, a method for pulse-width-modulated control of a drive current for an electric motor. The method includes the steps of starting a control pulse of a PWM signal in dependence on a periodic clock signal, ending the control pulse when the drive current exceeds a predetermined reference value, and subjecting the PWM signal to positive disconnection for a minimum switching time in each clock of the periodic clock signal.

According thereto, a PWM signal is generated for the purpose of modulating the drive current, and the control pulses of the PWM signal are started once a temporally periodic clock signal has been input, a control pulse being interrupted when the motor current reaches or exceeds a predetermined reference value. For the purpose of suppressing the long-wave components of the PWM signal, provision is made for the PWM signal within each period of the clock signal to be subjected to positive disconnection for a predetermined minimum switching time.

In one particularly simple embodiment of the method, the positive disconnection is achieved by a pulse input signal being ANDed to the clock signal for the purpose of generating the PWM signal. Independently of the form of the pulse input signal, the positive disconnection of the PWM signal is ensured by a binary signal, which assumes a “0” value during the minimum switching time within each period, being used as the clock signal. The fact that the positive disconnection can only be controlled by the form of the clock signal is due to the mathematical properties of a logic ANDing which always generates “0” as the output value as soon as one of the two input values has the value “0”. A binary signal is preferably used as the pulse input signal as it is provided by a conventional PWM controller as a PWM signal. As has already been mentioned, such a signal is set at the value “1” by a pulse of the clock signal, and is reset to “0” when the motor current exceeds a predetermined reference value.

The ANDing which is subjected to positive disconnection is simple in configuration terms owing to an AND gate, i.e. owing to an electronic standard component, which is connected downstream of a conventional current mode-based PWM controller. One input of the AND gate is in this case connected to the signal output of the clock generator.

Other features which are considered as characteristic for the invention are set forth in the appended claims.

Although the invention is illustrated and described herein as embodied in a PWM motor control in the current mode with positive disconnection, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematically simplified circuit diagram of a control unit, which controls an electric motor, having a current-management device for inputting a PWM signal, according to the invention;

FIG. 2 is a schematic circuit diagram of the current-management device shown in FIG. 1;

FIG. 3 is timing diagram of a switching cycle brought about by the current-management device shown in FIG. 2; and

FIG. 4 is a timing diagram as shown in FIG. 3 of a further switching cycle.

### DESCRIPTION OF THE PREFERRED EMBODIMENTS

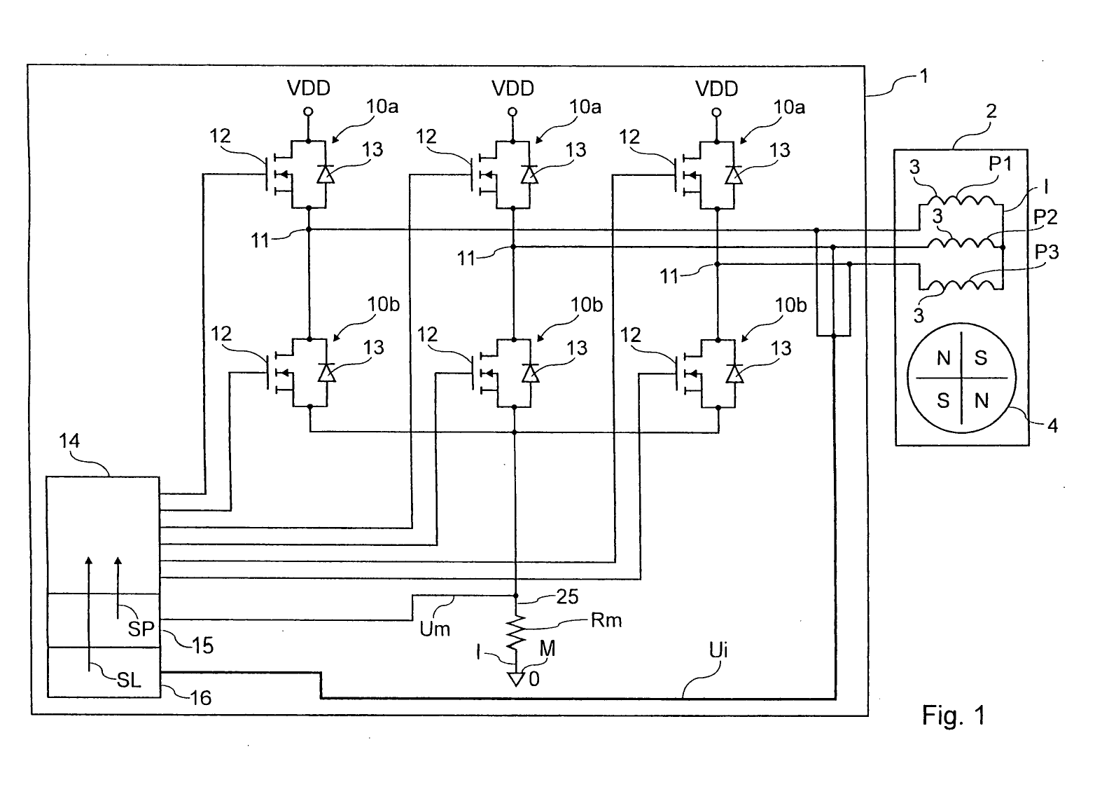

In all the figures of the drawing, sub-features and integral parts that correspond to one another bear the same reference symbol in each case. Referring now to the figures of the drawing in detail and first, particularly, to FIG. 1 thereof, there is shown a control unit 1 which supplies a drive current I to an electric motor 2. In the exemplary illustration shown in FIG. 1, the electric motor 2 is in the form of a three-phase synchronous motor. It correspondingly contains the three phases P1, P2 and P3 that are represented in the illustration by their respective field coil 3. The phases P1 to P3 are star-connected to one another within the electric motor 2. The electric motor 2 also contains a rotor 4 that has a permanent magnetic field and is only illustrated in FIG. 1.

In order to commutate, i.e. connect, the phases P1 to P3, the control unit 1 has six circuit breakers 10a and 10b, of which in each case one circuit breaker 10a is connected between a phase tap 11 of the respectively associated phase P1, P2, P3 and the operating potential VDD, and in each case one further circuit breaker 10b is connected between the phase tap 11 of the associated phase P1, P2, P3 and earth M. Each circuit breaker 10a, 10b contains a power transistor 12 (in particular MOSFET or IGBT) and a freewheeling diode 13 connected in parallel thereto. The power transistors 12 are controlled on the gate side by a phase controller 14.

The phase controller 14 is in turn controlled by a current-management device 15 and a rotor position detection unit 16. Both the phase controller 14 and the current-management device 15 and the rotor position detection unit 16 are preferably in the form of an electronic circuit. Parts of the functionality of the phase controller 14, the current-management device 15 and the rotor position detection unit 16 may if necessary also be realized by a microcontroller.

The rotor position detection unit 16 serves the purpose of detecting the position of the rotor field of the electric motor 2 with respect to the orientation of the phases P1, P2 and P3. The rotor position detection unit 16 feeds a position signal SL to the phase controller 14, and the phase controller 14 controls the circuit breakers 10a and 10b as a function of the position signal SL such that the magnetic field components of the phases P1 to P3 add up to an electromagnetic rotating field which rotates at the rotational frequency of the rotor 4. In this case, only two of the three phases P1 to P3 are always controlled. The in each case third phase P1, P2, P3 which is not controlled serves the purpose of measuring the back-EMF (electromagnetic force) induced by the rotor magnetic field in the phases P1 to P3. An induction voltage Ui fed into the phase lines by the back-EMF is tapped off at the phase lines and fed to the rotor position detection unit 16 as an input variable. The rotor position detection unit 16 evaluates the back-EMF in the form of sensorless control and, at each zero crossing of the back-EMF, generates a position impulse of the position signal SL.

On the other hand, the current-management device 15 serves the purpose of controlling the rotational speed and/or power of the electric motor 2. The current-management device 15 performs the regulation in the form of pulse-width modulation (PWM) in the current mode.

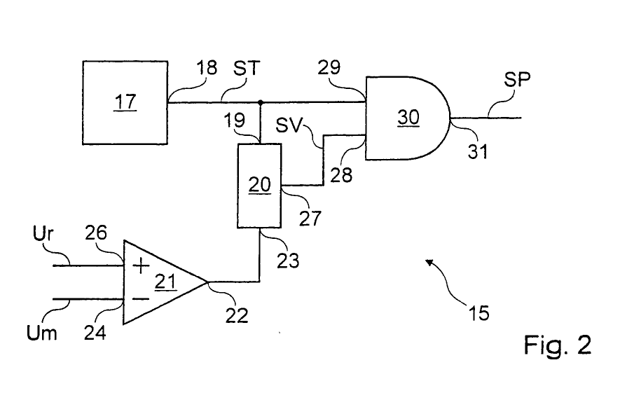

The configuration of the current-management device 15 is illustrated in more detail in FIG. 2 in a schematically simplified circuit diagram. The current-management device 15 depicted here contains a clock generator 17, whose signal output 18 is connected to a SET input 19 of a bistable switch 20. The current-management device 15 also contains a comparator 21, whose signal output 22 is connected to the RESET input 23 of the bistable switch 20. The measurement input 24 of the comparator 21 taps off a measurement voltage Um that is present across a measuring resistor Rm that is connected in a drive current line 25 (FIG. 1) of the control unit 1. The measurement voltage Um is, in accordance with Um=I·Rm, proportional to the drive current I flowing in the drive current line 25. A predetermined reference voltage Ur that can be adjusted for the purpose of regulating the rotational speed is applied to a reference input 26 of the comparator 21.

A signal output 27 of the bistable switch 20 and a signal output 18 of the clock generator 17 are connected to in each case one of two inputs 28 and 29, respectively, of an AND gate 30. The PWM signal SP can be tapped off at the signal output 31 of the AND gate 30.

The bistable switch 20 is understood to be an electronic component which outputs a logic signal, i.e. one which alternates in binary form between a “0” state and a “1” state. The output signal in this case changes from “0” to “1” when a signal pulse is applied to its SET input 19. The “1” state is maintained until a signal pulse is applied to the RESET input 23.

The comparator 21 is understood to be an electronic component which outputs an output signal that is dependent on the ratio of the voltages applied to its measurement input 24 and its reference input 26. The output signal in this case has the value “0” when the voltage Um applied to the measurement input 24 falls below the voltage Ur applied to the reference input 26 and a “1” value when the voltage Um applied to the measurement input 24 exceeds the voltage Ur applied to the reference input 26.

The AND gate 30 is understood to be an electronic component which only outputs an output signal with the logic value “1” when a signal of the value “1” is present at the two inputs 28 and 29, and otherwise its output signal has the value “0”.

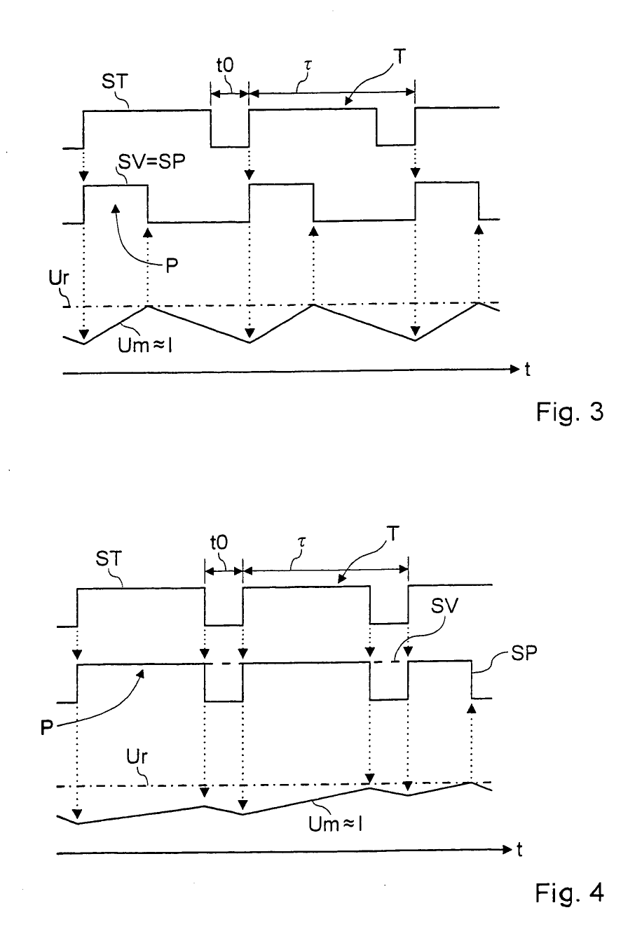

The clock generator 17 outputs, via the signal output 18, a clock signal ST, whose dependence on the time t is illustrated in FIG. 3. As can be seen from the diagram, the clock signal ST is a logic signal that is periodically repeated with a period duration τ. The period duration τ is approximately 50 to 70 μsec. This corresponds to a fundamental frequency of approximately 16 to 20 kHz. The clock signal ST thus contains only frequency components that lie at the outermost edge of or outside the frequency range which is audible to humans (<20 kHz).

One section of the clock signal ST with the period duration τ is referred to below as clock T. Within each clock T, the clock signal ST assumes the value “0” for a predetermined minimum switching time t0 that is preferably approximately 5% of the period duration τ. For the remaining duration of the clock T, the clock signal ST assumes the value “1”.

As shown in FIG. 2, the clock signal ST is present at the SET input 19 of the bistable switch 20 and triggers a switching process of the bistable switch 20 as soon as, at the beginning of each clock T, the value of the clock signal ST jumps from “0” to “1”. During the switching process, the value of a pulse input signal SV which is output at the signal output 27 of the bistable switch 20 changes from “0” to “1”. Since a “1” value is now present at the two inputs 28 and 29 of the AND gate 30, the AND gate 30 also switches to “1” on the output side and thus starts a control pulse P of the PWM signal SP. During the control pulse P, the value of the motor current I rises successively as a result of corresponding switching of the circuit breakers 10a, 10b, as can be seen in FIG. 3 with reference to the characteristic of the proportional measurement voltage Um.

The state of the bistable switch 20, and thus the state of the pulse input signal SV, is maintained until the drive current I exceeds a predetermined threshold value, and, as a result, the measurement voltage Um which is proportional thereto also reaches the reference voltage Ur or exceeds it. As a result, the comparator 21 switches from “0” to “1” on the output side, as a result of which the reset process of the bistable switch 20 is triggered such that the pulse input signal SV is reset from “1” to “0”. The respective causal relationship between the state of the signals ST and Um, on the one hand, and a change in value of the pulse input signal SV or PWM signal SP, on the other hand, is indicated in FIG. 3 by dotted arrows.

As long as, as is illustrated in FIG. 3, the measurement voltage Um reaches the reference voltage Ur within each clock T, the pulse input signal SV is also reset to “0” within each clock T under the influence of the comparator 21. As a result of the logic properties of the AND gate 30, the PWM signal SP follows the pulse input signal SV. The current-management device 15 in this case operates as the current-management device of a conventional PWM controller in the current mode.

On the other hand, if, as is illustrated in FIG. 4, the rate of rise of the drive current I, and thus the rate of rise of the measurement voltage Um, is so low that the latter does not reach the reference voltage Ur within a clock T, the AND gate 30, following the clock signal ST, positively disconnects the PWM signal SP for the minimum switching time to and thus interrupts the control pulse P, whereas the pulse input signal SV maintains the value “1”.

Long-wave frequency components of the drive current I (and corresponding to the measurement voltage Um) are thus largely suppressed, as a result of which audible noise production during operation of the electric motor 2 is effectively reduced.

This application claims the priority, under 35 U.S.C. § 119, of German patent application No. 103 58 129.4, filed Dec. 12, 2003; the entire disclosure of the prior application is herewith incorporated by reference.

1. A method for pulse-width-modulated control of a drive current for an electric motor, which comprises the steps of:
starting a control pulse of a PWM signal in dependence on a periodic clock signal;
ending the control pulse when the drive current exceeds a predetermined reference value; and
subjecting the PWM signal to positive disconnection for a minimum switching time in each clock of the periodic clock signal.

2. The method according to claim 1, which further comprises:
generating the PWM signal by a logic ANDing between the periodic clock signal and a pulse input signal; and
using a binary signal, which assumes the value “0” during the minimum switching time within the clock, as the periodic clock signal.

3. A control unit for generating a drive current for an electric motor, the control unit comprising:
a current-management device for outputting a PWM signal for pulse-width-modulating the drive currents said current-management device starting a control pulse of the PWM signal in dependence on a periodic clock signal, and ending the control pulse when the drive current exceeds a reference value, said current-management device configured to positively disconnect the PWM signal for a minimum switching time in each clock of the clock signal.

4. The control unit according to claim 3, wherein said current-management device containing:
an AND gate having an input side and an output side;
a clock generator having a signal output;
a bistable switch having a set input, a reset input, and a signal output; and
a comparator having an input side and an output side;
said signal output of said clock generator connected to said set input of said bistable switch;
said comparator receiving on said input side a measurement voltage which is proportional to the drive current and a reference voltage;
said comparator connected on said output side to said reset input of said bistable switch;
said input side of said AND gate connected to said signal output of said clock generator and to said signal output of said bistable switch;
the PWM signal can be tapped off on said output side of said AND gate.

5. The control unit according to claim 4, wherein said clock generator outputs the periodic clock signal as a binary signal which assumes a value “0” for a duration of the minimum switching time during each clock.
